(19) United States
(12) Patent Application Publication
(10) Pub. No.: US 2010/0177319 A1
(43) Pub. Date: Jul. 15, 2010

(54) OPTICAL IMAGING OF PHYSICAL OBJECTS

(75) Inventors: David Towers, Leeds (GB); Catherine Towers, Leeds (GB); Zonghua Zhang, Edinburgh (GB)

Correspondence Address: YOUNG BASILE, 3001 WEST BIG BEAVER ROAD, SUITE 624, TROY, MI, 48084, US

(73) Assignee: THE UNIVERSITY OF LEEDS, Leeds, UK (GB)

(21) Appl. No.: 12/377,180

(22) PCT Filed: Aug. 13, 2007
(86) PCT No.: PCT/GB07/03088

§ 371 Date: Jul. 20, 2009

(30) Foreign Application Priority Data
Aug. 11, 2006 (GB) 0615956.0

(51) Int. Cl. G01B 11/25; G01B 11/02

(52) U.S. Cl. 356/511; 356/610

(57) ABSTRACT

A method for combining shape data from multiple views in a common co-ordinate system to define the 3-D shape and/or colour of an object, the method comprising: projecting one or more optical datum(s)/markers onto the object surface; projecting light over an area of the object surface; capturing light reflected from the surface; using the optical datum(s)/markers as reference points in multiple views of the object, and using the multiple views and the reference points to determine the shape of the object.

The present invention relates to optical measurement techniques for capturing physical objects in terms of their geometrical shape, colour and appearance or texture.

### BACKGROUND OF THE INVENTION

Fringe-projection-based 3D imaging systems have been widely studied because of their full-field acquisition, fast processing, high resolution and non-contact operation. In these, a set of substantially parallel fringes is projected across an object to be measured and the object is imaged using a camera. The camera and fringe projector are spatially separated such that there is an included angle between their optical axes at the object. The x, y position of the object may be determined from the pixel position on the camera. The depth of the object, z, is encoded in the position of the fringes in the captured images. Each projected fringe defines a thick plane across and through the depth of the measurement volume. Existing 3D imaging systems use fringes with an even period, so the projected fringes on the planes vertical to the imaging optical axis have an uneven period because of the non-parallel axes of camera and projector. The relationship between depth and phase is a complicated equation of the co-ordinates vertical to the fringe patterns. With an arbitrary shaped object in the field of view the fringes become distorted as a function of the object's shape and the geometry of the setup. Hence, by analysing the deformed fringe patterns received at the camera, the shape of the object can be determined.

To uniquely and unambiguously measure the object depth a robust method is needed to count or otherwise determine the order of the fringes. To achieve this multi-wavelength techniques have been used to determine fringe order independently at every pixel and thereby to enable the measurement of discontinuous objects, see for example H 0 Saldner, J M Huntley, “Profilometry using temporal phase unwrapping and a spatial light modulator based fringe projector”, Optical Engineering, Volume 36, pp. 610-615, 1997; C E Towers, D P Towers, J D C Jones, “Generalized frequency selection in Multi-frequency interferometry,” Optics Letters, Volume 29, pp. 1348-1350, 2004 and D P Towers, C E Towers, and J D C Jones, “Phase Measuring Method and Apparatus for Multi-Frequency Interferometry,” Patent PCT/GB2003/003744, the contents of which are incorporated here by reference. However, multi-wavelength techniques require knowledge of the number of fringes projected at each wavelength. Even small errors in the expected number cause large errors in the calculated fringe order and hence in the calculated object shape. A colour fringe projection system was explored recently, see the reference Zonghua Zhang, Catherine E. Towers, and David P. Towers, “Time efficient colour fringe projection system for simultaneous 3D shape and colour using optimum 3-frequency selection,” Optics Express. Volume 14, pp. 6444-6455, 2006. However, a shift in the fringe patterns due to the lateral chromatic aberration from different colour channels can cause the wrong fringe order calculation.

In many applications, all surfaces of a three-dimensional object must be measured. Hence, data must be captured from multiple viewpoints. Ideally the shape data from multiple viewpoints is combined into a single co-ordinate system whilst at least maintaining the accuracy of the shape information from any single view. This problem may be resolved physically using two types of arrangement. For smaller objects the shape sensor maybe fixed and the object moved around in front of it, whereas for larger objects the object maybe fixed and either multiple shape sensors or a single shape sensor moved around the object. In one arrangement, a high accuracy calibrated traverse is used to carry the sensor system or the object. However, this approach is inflexible as the traverse imposes size and weight limits on the object, and mounting the sensor system can be problematic. An alternative approach is to use a data fitting algorithm, i.e. use the captured shape data itself to determine the co-ordinate transformations needed to bring the data from each view onto a common co-ordinate system. This relies on an overlapping region between each view. The larger the overlap the better the accuracy of the co-ordinate transformation, but the more views required to map the entire object. A problem with this is that for large objects the transformation errors tend to accumulate, so that the overall shape accuracy is many times worse than that in a single view. Yet another approach for combining multiple viewpoints uses photogrammetry based on a set of coded targets applied to the object to form a set of co-ordinate references. The position of the targets is determined using many images in which more than three targets are visible in each image. Digital photogrammetry techniques are used to determine the positions of the targets. Separate high resolution shape capture techniques, e.g. fringe projection, are then used to measure the free form object surface between the targets and the targets themselves are used to lock the free form surface data to the global co-ordinate system. Whilst this approach provides good scalability for objects of arbitrary dimensions, portions of the object surface are occluded by use of the targets and it is time consuming owing to the photogrammetry algorithms used.

The multiview techniques described above allow the shape of an object to be determined. However, to make the image of the object as realistic as possible, its surface features or texture also have to be imaged. These features are typically on length scales from a fraction of a wavelength to a few wavelengths, i.e. 0.1 μm to 10 μm. Such information is not captured by existing techniques/systems. Instead, generic appearance data in the form of a bi-directional reflectance distribution function (BRDF) is applied to particular surfaces manually from libraries for generic materials. BRDF is a measure of how light is scattered by a surface, and so can provide a measure of the surface texture. The BRDF is determined by the detailed structure of the surface at length scales that extend to less than the wavelength of light, i.e. <0.1 μm. The BRDF is a function that depends on a number of parameters: the angle of incidence of the light hitting the surface, the angle of reflection, the wavelength (colour) of the light and the polarisation.

Physically the BRDF can be thought of as containing three components: a direct reflection or specular component, a haze around the specular reflection and a diffuse or Lambertian component that is approximately uniform across the field. The specular and haze components require knowledge of the surface normal at the point of interest in order to quantify the effects. The more matt or diffusely scattering a surface is the more spread out is the haze component and the dimmer the specular reflection. Current instruments for measurement of BRDF employ a multi-colour light source and typically examine a flat object as the surface normal can be easily defined, see for example P Y Barnes, E A Early, A C Parr, “NIST Measurement Services: Spectral Reflectance” NIST Special Publication 250-48, National Institute for Standards, Gaithersburg, Md., 1998, the contents of which are incorporated herein by reference. The BRDF is scanned out by moving the object or source and detector points to map out the angular function of the BRDF at a suitable resolution. This is a time consuming process and furthermore may not be representative of the actual appearance of an object with a similar surface as the surface details cannot be reproduced exactly, particularly when the object that is being imaged has surfaces of arbitrary geometry where the orientation of the surface normal is not known.

Another problem with many existing multi-view shape systems is that they require calibration. This can be difficult and time consuming. A number of papers describe shape calibration based on a geometric model of the system using ‘pinhole’ models for the projection and imaging lenses used. These techniques require the system calibration data to be stored on a per pixel basis, for example a third order polynomial fit requires 16 bytes of data storage per pixel, typically >16 MB for the full field of view. Recent examples include: H Guo, H He, Y Yu, M Chen, “Least squares calibration method for fringe projection profilometry”, Optical Engineering, Volume 44, 033603, 2005; L Chen, C J Tay, “Carrier phase component removal: a generalized least-squares approach”, Journal of Optical Society of America A, Volume 23, pp 435-443, February 2006, the contents of which are incorporated herein by reference. Alternative techniques have been reported that form a calibration between unwrapped phase and object depth without using a geometric model. However, these also require calibration coefficients to be stored on a per pixel basis, for example as described by O Saldner, J M Huntely, “Temporal phase unwrapping: application to surface profiling of discontinuous objects”, Applied Optics, Volume 36, pp 2770-2775, 1997, the contents of which are incorporated herein by reference. Further alternative techniques include a combination of unwrapped phase calibration with models (including lens aberration terms) derived from photogrammetry. Again per pixel storage of calibration coefficients is required, see M Reeves, A J Moore, D P Hand, J D C Jones, “Dynamic shape measurement system for laser materials processing”, Optical Engineering, Volume 42, pp 2923-2929, 2003, the contents of which are incorporated herein by reference. A problem with all of these techniques is that they require pixel by pixel storage. This means that memory requirements for the system are significant and processing of the data can be time consuming.

An object of the present invention is to provide an improved system and method for imaging three-dimensional objects.

### SUMMARY OF THE INVENTION

According to one aspect of the present invention, there is provided a method of combining shape and/or colour data from different viewpoints of an object comprising projecting one or more optical datums onto the object surface and analysing light reflected from that surface.

By ensuring that there are a number of datums that are common between neighbouring fields of view, a co-ordinate transformation can be determined between the data from the two views and hence the information put into a common co-ordinate system. This approach is applicable to any form of full-field shape measurement and can be used to accurately combine multiple point clouds together from different viewpoints.

The optical datums could be used in place of conventional photogrammetry markers that are applied to a surface or used on cards placed against the surface. Using optical markers instead of conventional photogrammetry markers is advantageous, because the optical markers have high stability (cold source) and do not occlude the surface in any way. As will be appreciated, conventional photogrammetry algorithms could be applied to images captured of the datums, thereby to determine the object's shape. Another advantage of using optical datums is that accuracy in 3-D space is improved. In addition, there is no need for an accurate traverse system to be used. Instead the optical datums and the object need to remain fixed with respect to each other during the multi-view data capture process.

Preferably, the optical datums are projected from a cold or non-thermal source, for example, single mode fibres. The use of single mode fibres is advantageous as the beam pointing stability from these is ˜1000× better than a thermal source such as a laser diode or LED. For a laser source, beam-pointing stability is typically 10⁻³ radians ° C.⁻¹ and therefore over a lever arm of 1 m, a position uncertainty of 1 mm ° C.⁻¹ is obtained. However, the use of a non-thermal source, i.e. the beam produced from a fibre optic, gives a beam pointing stability of 10⁻⁶ radians ° C.⁻¹. Hence over the same lever arm a position uncertainty of 1 μm ° C.⁻¹ is obtained. In practice, optical datums produced using fibre optics are compatible with either a shape sensor that is moved around a fixed object or where the object and datum assembly is moved in front of a static shape sensor.

Preferably, each optical datum is sized so that it is seen as a group of pixels at the imaging camera. This is advantageous, because the shape data at each pixel typically contains a measurement uncertainty that is composed of systematic and random components, but the random uncertainty components over a group of contiguous pixels will average out. By calculating a weighted average of the shape information over a plurality of pixels, the overall uncertainty in the x-y-z position co-ordinate for the optical datum can be reduced.

The optical datums may be generated using a lens to obtain the desired spot size on the object.

According to another aspect of the invention there is provided a system comprising an optical shape sensor that is operable to project light onto an object; capture light reflected from the object and use the captured light to determine the shape of at least part of the object, and means for determining an angular spread of the captured light about a normal to a surface of the object, the normal being relative to the determined shape.

The major BRDF features are around the directly reflected rays about the surface normal, the angular spread of these rays identifying the degree of glossiness or diffusivity of the surface. Using an optical shape sensor enables a surface to be positioned at the appropriate angle between the projector and camera to specifically measure the behaviour of the object's reflectance around this position. This may be achieved automatically using a motorised rotary traverse system of low specification (few degrees accuracy).

Areas of the surface maybe identified manually or automatically for measurement of the local BRDF and thereafter applied to similarly coloured sections of the object surface. This represents a degree of automation and intelligence in the sensor system to capture the important aspects of the object's appearance that is not found in existing systems. This can only be achieved in a system offering shape, and multi-view information.

According to yet another aspect of the invention there is provided an optical shape sensor that has a projector for projecting optical fringes onto an object, a camera or other suitable detector for capturing fringes reflected from the object, and means for using the captured light to determine the shape of the object, characterised in that the projected fringes are unevenly spaced.

Preferably the unevenly spaced projected fringes are selected so that they remove distortion/aberration. This is advantageous and may have widespread applicability in either optical metrology or displays.

Preferably, the uneven fringes projected are such that the fringes at the object are evenly spaced. This provides a simple and linear relationship between the phase of the projected fringes and the depth of the object. This can be used to simplify calibration of the sensor, because the linear relationship can be characterised using a reduced set of coefficients, thereby reducing the amount of calibration data that needs to be stored. This means that a simple approach to shape calibration is possible by means of a calibration object containing a step height change. This allows for a significantly quicker and more straightforward calibration than the existing technique of scanning a flat plane through the measurement volume. A further advantage of arranging the fringes projected onto the object to be evenly spaced is that a virtual reference plane may be used rather than measured data, thereby allowing the noise in any measured shape data to be reduced.

The uneven-ness of the projected fringes may be selected to compensate for lens distortions thereby improving the accuracy of the shape measurements obtained.

Preferably, the projector is operable to project a computer-generated image onto the object. Using computer-generated images improves flexibility.

According to another aspect of the present invention, there is provided a method for compensating for chromatic aberration in a colour fringe projection system having a projector for projecting a plurality of different colour light fringes onto an object and a camera for capturing light fringes reflected from the object, the method comprising scaling the captured fringes to an expected number of fringes for each colour channel.

By scaling all of the captured fringes to an expected number of fringes, the multi-wavelength data can be combined between the colour channels. In practice, this means that multi-colour and shape data could be acquired simultaneously. For a conventional red, green and blue system this would provide a time saving of a factor of three. The flexibility to utilise information from any of the colour channels also provides the flexibility to optimise the data acquisition process for objects of arbitrary colour.

The linear compensation method of the present invention may have widespread applicability to many optical metrology systems that incorporate colour.

### BRIEF DESCRIPTION OF THE DRAWINGS

Various aspects of the invention will now be described by way of example only, and with reference to the accompanying drawings, of which:

FIG. 1 is schematic view of an optical shape sensor system;

FIG. 2 is a schematic view of another optical shape sensor system, in which optical datums are used as reference points;

FIG. 3 is a plan view of the relationship between a fringe projector with a digital micromirror device along line AN, a CCD camera chip plane and a reference R;

FIG. 4 is a schematic illustration of an arrangement for measuring N/f;

FIG. 5 shows the geometry of an imaging system (2D) for deriving the relation between phase and depth;

FIG. 6 shows various images of a plate;

FIG. 7 shows the measured depth using uneven and even fringe projection for the middle row with the plate positioned at z=5 mm, in which the X-axis represents the pixel positions along a row with a range 1,2,3 . . . , 1024, and the vertical axis is the depth of the surface in mm;

FIG. 8(a) shows the measured depth as a function of row number for uneven fringe projection;

FIG. 8(b) shows standard deviation as a function of row number for uneven fringe projection;

FIG. 9 shows the effects of chromatic aberration effects produced by a lens;

FIG. 10 shows an example of a shape measurement from a flat board when chromatic aberration is not removed from a multi-colour fringe projection system;

FIG. 11 shows a graph of intensity captured in three colour channels when equal numbers of fringes are projected on each channel;

FIG. 12 shows the difference in unwrapped phase across an image between red and green channels (top) and green and blue channels (bottom) for 3 rows of the image and when the same number of fringes are projected in each colour channel, and

FIG. 13 is an example of a shape measurement from a flat board when chromatic aberration is removed from the phase data in a multi-colour fringe projection system.

### DETAILED DESCRIPTION OF THE DRAWINGS

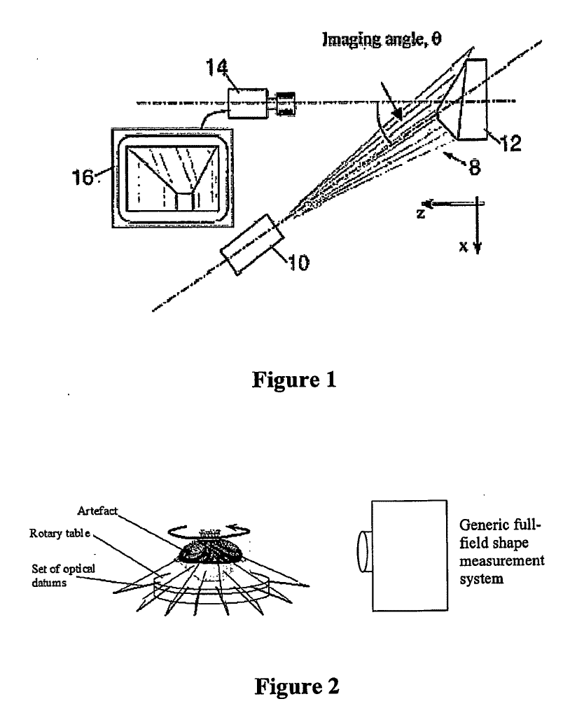

FIG. 1 shows an optical imaging system for capturing an image of a 3D object. This has a computer controlled data projector, preferably a digital lighting processing (DLP) projector, a camera to capture images and a computer to process the data. Preferably, the projector is operable to project multi-colour data onto the test object, so that the system is a colour full field shape measurement system. Means are provided to alter the relative position between the shape measurement system and the test object. This may take the form of a motorised traverse to move either the shape measurement system around the test object or move the test object in front of the shape measurement system. Light captured by the camera is processed using the computer to determine the shape, and optionally the colour, of the object. In some embodiments the captured light is also processed to determine the BRDF.

### Multi-view Shape Registration Using Fibre Optic Datums

FIG. 2 shows a fixed shape sensor that is operable to use optical datums to identify points on the object surface. In this case, fibre optic cables are affixed to a rotary traverse on which the test object is located, thereby to project visible optical datums onto the object's surface. An alternative configuration would have the fibres illuminating a set of points around a circular disc positioned underneath the object and optionally a disc positioned above the object. In a further alternative configuration the object could be fixed and a set of fixed optical datum projectors could be arranged to illuminate a suitable number of points on the object surface.

In use, the optical datums are projected onto the object and images of these are captured by the shape sensor. The image of the optical datums can be acquired simultaneously with the image of the object. Alternatively, the images could be acquired sequentially. In the latter case, the system must remain in the same position for the capture of the full field data and the images of the optical datums.

The optical datum may be of any suitable shape and size. For example, each optical datum may be sized so that it is seen as a group of pixels at the imaging camera. The shape data at each pixel typically contains a measurement uncertainty that is composed of systematic and random components, but the random uncertainty components over a group of contiguous pixels will average out. By calculating a weighted average of the shape information over a plurality of pixels, the overall uncertainty in the x-y-z position co-ordinate for the optical datum can be reduced. The optical datums may be generated using a lens or any other suitable beam shaping optics to obtain the desired spot size on the object.

Sufficient datums must be provided to give at least three points in each image view. The datums may be used in a number of ways: as markers to identify co-ordinates from a full-field shape sensor, where image processing techniques may be used to obtain increased resolution through weighted averaging or data fitting. Alternatively, the optical datums could be used in place of conventional photogrammetry markers processed using typical photogrammetry algorithms. In this case, conventional photogrammetry algorithms could be applied to images captured of the datums, thereby to determine the shape of the object. However, advantageously, these datums can be switched on or off electronically to enable automation of data capture and they also do not occlude the object surface. The full-field shape sensor could then be tripod mounted and moved around the object or alternatively the object maybe moved in front of a fixed shape sensor. In either case, high resolution surface patches are acquired where each patch contains at least three optical datums with each datum uniquely identifiable by capturing individual images where only a single datum is activated. By identifying the pixels in the image addressed by the optical datum the corresponding 3-D co-ordinate can be found by referencing the full field shape sensor data. By ensuring that there are sufficient optical datums that are common between neighbouring views, i.e. ≧3, the co-ordinate transformation between the views can be found.

Using optical datums as reference points in an optical shape sensor provides numerous advantages, for example, physical markers to not occlude the surface of the object. In addition, the optical datums can be switched on/off, e.g. electronically or using a mechanical shutter, enabling automation of data capture. In addition, only a single high-resolution camera is needed for both the full field shape sensor and the data from the optical datums. By ensuring that the size of the optical datum on the object covers a finite number of pixels, either sub-pixel interpolation or a weighted average of the full-field shape data maybe used to increase the accuracy of the co-ordinate calculated for each datum. This approach can be used for either an object mounted on a suitable traverse or a fixed object around which the shape sensor is moved. However, the traverse/sensor movement system used in either case would not have to be accurate.

### BRDF Measurement Using a Multi-View Shape Sensor

The multi-view shape sensor in which the invention is embodied can be configured to capture the essential features of the BRDF in order to obtain enhanced photo-realism of objects. To obtain a BRDF, it is essential to know the orientation of the surface with respect to the light source and the detector. In a shape measurement system, such as shown in FIGS. 1 and 2, this is known or can be determined from the measured shape data. If the shape capture system is colour sensitive, e.g. red, green and blue, then the colour dependent nature of the surface can be obtained in a way that is compatible with current display technologies (i.e. three primary colours), using conventional object rendering systems. The natural process of rotating either the object in front of the shape and colour sensor or moving the sensor around the object provides angularly resolved intensity data that can be used to construct a coarse BRDF.

The BRDF may be constructed either for the entire object or for selected regions. If the object is made up of different materials or surface finishes the regions maybe identified by their colour or variation in appearance as a function of angle of illumination and angle of detection. Having captured the shape and colour data for the entire object, the critical elements of the BRDF, i.e. around the specular reflection, maybe captured by automatically positioning the object to put the surface normal near the bisector of the light source and the detector that make up the shape measurement system. Higher resolution BRDF can be achieved by changing the relative position of the object and sensor system in smaller steps. In this way, the BRDF of the actual object is obtained rather than that of a representative flat test sample.

3D Imaging System with Uneven Fringe Projection

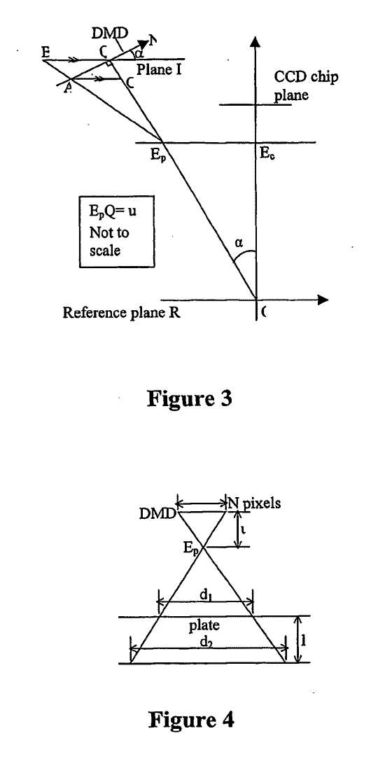

In accordance with another aspect of the invention there is provided an optical shape sensor that has a projector for projecting unevenly spaced light fringes onto an object. Preferably, the uneven fringes are such that the fringes at the object are evenly spaced. Using this aspect, a simplified calibration technique can be implemented. This aspect of the invention will be described with reference to FIGS. 3 to 5. A plan view, X-Z plane, of the geometry of the projector is shown in FIG. 3. The Z-axis is defined along the optical axis of the camera with the projected fringes orthogonal to the X-axis. The optical axes of the projector and camera lie in the X-Z plane and cross at O, which is contained in a reference plane R from which the object's depth is measured. A pinhole camera model is adopted with centres at Ep and Ec for the projector and camera respectively. The baseline between Ep and Ec is L , L₀ is the object distance OEc . The angle between the optical axes of the projector and camera is α.

The pinhole positions of the projector lens, Ep, and camera lens, Ec, equivalently the exit and entrance pupils respectively are shown. Defining a virtual plane I parallel to the reference plane R, then the desired constant period fringes on R are obtained if the fringe period is constant on I. Q is defined at the centre of a digital micromirror device (DMD) such that QEp is an extension of the optical axis of the projector. QN is a local axis on the DMD and perpendicular to both the fringes and the projector's optical axis. A is an arbitrary point on axis QN with coordinate n. The back-projection of A on to the virtual plane I gives point B and AC is constructed parallel to I giving similar triangles EpQB and EpCA. The fringe period is defined as P_{I} on the virtual plane I (required to be a constant), Pₙ at point A along the DMD chip and P_{AC} at point A along AC (parallel to I). So, by similar triangles and defining EₚQ as u:

$$\begin{matrix}{P}_{AC} = \frac{AC}{BQ} {P}_{I} & ( 1 a ) \\ BQ = \frac{u}{{E}_{P} C} AC . & ( 1 b )\end{matrix}$$

From triangle ACQ, P_{AC}=(AC/n)Pₙ, hence from equation (1a) the fringe pitch required on the DMD, Pₙ is:

$${P}_{n} = \frac{n}{BQ} {P}_{I} \qquad ( 2 )$$

An expression for BQ can be found in terms of the system geometry. In triangle ACQ: n=AC cos α and QC=n tan α, and using EₚC=u−QC in equation (1b), BQ=nu/(u cos α−n sin α). Substituting BQ in equation (2) gives

Pₙ=P_{I}(cos α−n/u sin α). (3)

The coordinate n can be defined as a pixel index on the DMD. With N as the number of pixels along a row, N/u can be found by measuring the projected widths, d1 and d2, on a plate located at two positions in front of the projector with a known separation 1, as shown in FIG. 4, where:

N/u=(d₂−d₁)/l. (4)

The angle α between the two axes is determined geometrically. Using the obtained values for α and N/u, equation (3) defines fringes with variable period along a row of the DMD with the same fringes having the desired constant period P₀ across the reference plane R.

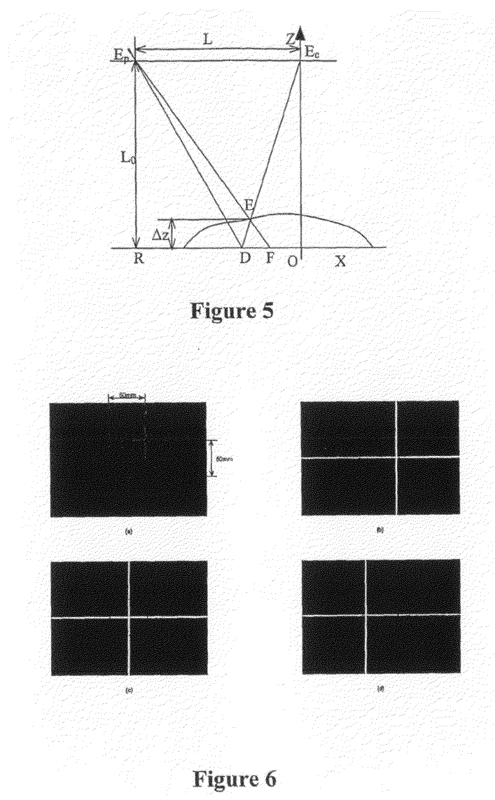

The overall system geometry in the X-Z plane is shown schematically in FIG. 5, following the assumption made above that the fringes are orthogonal to the X-axis. Taking D as a random point on the reference plane R then E is the corresponding point on the object surface that is imaged on the same pixel of the CCD camera. The projected ray through E intersects the reference R at point F, so E and F have the same unwrapped phase. According to the similar triangles EₚEE_{c} and FED,

$$\frac{DF}{L} = \frac{Δ z}{{L}_{0} - Δ z} , \qquad ( 5 )$$

where Δz is the object depth relative to the reference plane R, L and L₀ are the baseline and working distance respectively as shown in FIG. 4. Since on the reference plane R, the constant fringe period is P₀, DF=ΔΦP₀/2π, here ΔΦ is the difference in unwrapped phase obtained with the measured object and the reference plane R at that particular pixel. Therefore, with even fringes in the measurement space, the relation between depth and phase is

$$Δ z = \frac{Δ φ {P}_{0} {L}_{0}}{2 π L + Δ φ {P}_{0}} = {L}_{0} / ( 1 + \frac{2 π L}{Δ φ {P}_{0}} ) . \qquad ( 6 )$$

For a 3-D imaging system by using uneven fringe projection, the relation between phase and depth is just a function of the systematic parameters and is independent of pixel position. Therefore, one coefficient set is sufficient to relate depth and phase, instead of a Look-Up Table (LUT) to store the coefficient sets for each pixel during calibration and measurement. Consequently memory usage is greatly reduced for depth calculation, by a factor up to the number of pixels on the detector.

Since the relation between phase and depth is independent of pixel position, the spatial resolution along the X and Y axes has no effect on the depth calculation provided that the fringes are sufficiently resolved to give suitable resolution in the phase measurements. In principle, the depth calibration (for the constant terms in equation (6)) can be obtained separately from X and Y calibration. Moreover, the phase has a linear relation to pixel position along the X-axis, so a virtual plane rather than a measurement from a physical reference plane can be used to reduce measurement uncertainty.

To implement the theory set out above requires the projector and camera to be configured and the geometric parameters in equation (3) for the projector to be estimated. To locate the projector and to allow the CCD and DMD axes to be set parallel, an image of a cross was projected onto a flat calibration plate mounted on a linear translation stage. The plate was oriented parallel to the reference plane R with the translation stage parallel to the Z-axis. By traversing the plate forwards and backwards the camera and projector orientation could be adjusted until a purely horizontal motion of the cross was obtained in the image.

Even fringes in the measurement volume are established by modifying the values for N/u and α in equation (3). An iterative process was developed to optimize these two values based on achieving a linear phase distribution across a row of pixels from a flat measurement target. For the results presented here, the following parameters were used: N/u=0.433 and α=23.5°.

Calibration of the geometric constants in equation (6) is essential in order to calculate surface depth from measurements of the unwrapped phase. Rather than measure the parameters P₀, L and L₀ directly, calibration coefficients in equation (6) are obtained by moving a flat plate in known equal steps along the viewing axis to give a collection of corresponding values for Δz and ΔΦ.

In practical experiments it is found that the principal deviation from the theory set out above is due to geometric lens distortions. These effects can be generated from both the projector and camera lenses. However, the quality of the built in lenses in reasonably priced data projectors gives a considerably larger contribution than that from good quality camera lenses. Furthermore, geometric lens distortions can be incorporated into the uneven fringe projection model. Experimental evaluation of the projector showed that the dominant term is radial distortion, which can be modelled to a first order as a quadratic (even) function. If k is the radial distortion coefficient and r is a radial distance from the principal axis of the lens, then equation (3) can be re-written as:

P_{A}=(cos α−n(1+kr²) sin α/u)P_{I} (7)

Thus the uneven fringe patterns generated at the projector compensate for the off-axis projection angle, α, and the first order radial distortion generated by the projector lens. In the experiments reported here this model has been adopted using an experimentally determined value for k. In a similar way, higher order radial distortion terms or other forms of geometric distortion could be incorporated into equation (7).

Using the proposed uneven fringe projection method, a colour fringe projection system was calibrated. The experimental system had the following parameters: N/f=0.433 (d2=29.3 cm, d1=22.8 cm, 1=15.0 cm) and α=23.5 degrees. These values were obtained by elaborating the measured α and N/f, since the measured absolute phase on the reference plane should be a straight line for each row. A steel plate with white spray on the surface was used as the test object to avoid minor reflection. The plate was mounted on a micrometer with a precision of 10 microns. Four holes were made in the centre of the plate to calibrate the x- and y-coordinates. The horizontal and vertical distances between two holes were 50 mm, as shown in FIG. 6(a). The plate was positioned on a linear translation stage with a precision of 10 microns (M-443-4 and SM-50 from Newport). One point (the centre of the four holes) on the plate was defined as the origin of the coordinate system O-XZ and should be in the centre of the camera, so that when the plate is translated forward and backward along the stage the captured point is always in the centre of the camera. In order to locate the projector, a cross in the centre of one frame was generated in the software and was sent to the DLP projector. The cross should be superposed on the origin O and the vertical and horizontal lines coincide with the middle column and row in the captured frame, respectively, when the plate is in the reference position, as shown in FIG. 6(c). The middle column and row should be across the centres of the two horizontal holes and the two vertical holes, respectively. When the plate was moved forward and backward, the cross just moved along the horizontal line connecting the centres of the two holes in the captured frames, as shown in FIGS. 6(b) and (d).

The plate was moved forward and backward five times respectively with a step 10 mm. With respect to the reference plane, the distances are −50, −40, −30, −20, −10, 10, 20, 30, 40, and 50 mm. The three-frequency method described by C. E. Towers, D. P. Towers, and J. D. C. Jones, “Absolute fringe order calculation using optimised multi-frequency selection in full-field porfilometry,” Opt. Lasers Eng. 43, 788-800 (2005), the contents of which are incorporated herein by reference, was used to calculate the absolute phase and for each frequency the four-image phase shift algorithm was used to calculate the wrapped phase, so twelve frames were captured at each position and the absolute phase maps were obtained. In comparison, even fringe projection was also used to calculate the absolute phase at each position. The obtained absolute phases in these positions were used to calibrate the system. The plate was moved to the positions −45, −5, 5 and 45 mm and these positions were used to test the performance of the calibration. Since the fringes are parallel in the column direction, all the rows in a phase map have approximately similar values. The middle row was chosen for the calibration and test. Of course, because of the distortion of the projected and captured fringes, the distributions of phase values among rows are somewhat different.

In order to evaluate the proposed uneven fringe projection method, the average measured distance (AMD) and the standard deviation (STD) for the middle row were estimated. The measured distance (MD) along the middle row is zₙ^{m}, n=1, 2, . . . , N−1, N, and N is the sampled number in the row, so STD and AMD are defined as

$$\begin{matrix}STD = {( \frac{1}{N} {\sum }_{n = 1}^{N} {( {z}_{n}^{m} - \overline{{z}^{m}} )}^{2} )}^{1 / 2} , & ( 8 ) \\ AMD = \overline{{z}^{m}} = \frac{1}{N} {\sum }_{n = 1}^{N} {z}_{n}^{m} , & ( 9 )\end{matrix}$$

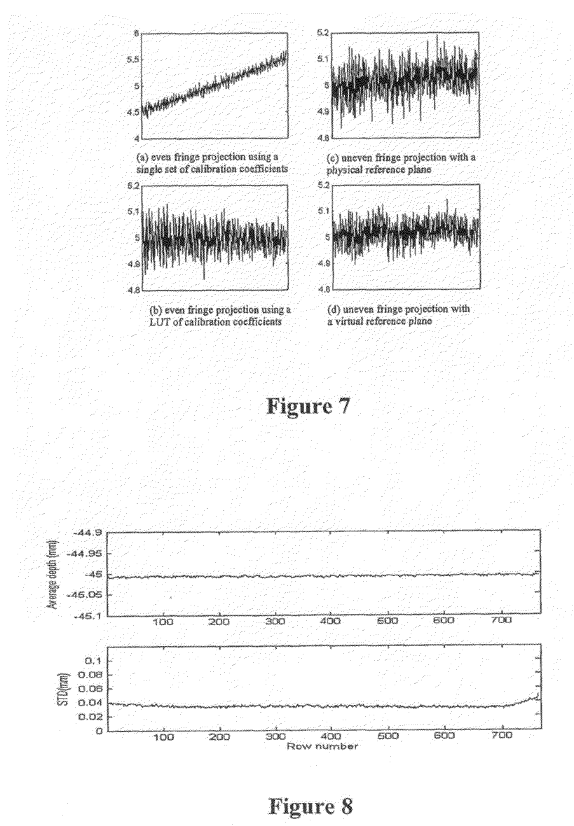

The actual translated distance (TD) controlled by the stage is known. For uneven fringe projection, the depth just relates to the relative phase and the systematic parameters, and one coefficient set is needed by averaging all the coefficient sets along the row to get accurate values. While for even fringe projection, since the relationship between depth and phase is a function of the position, x-coordinate, along the row direction, an LUT has to be built up to contain the coefficient sets. For even projection without LUT, an average value of N coefficient sets was used to calculate the results. Table 1 shows the values of AMD and STD in different conditions. Under even and uneven fringe projections, AMD have the similar values. When a virtual reference plane is used with uneven fringe projection, the values of STD are better than without a virtual reference plane (a factor of about 1.31, instead of the theoretically expected 1.414, because of the non-flatness of the steel plane). Even fringe projection without a pixel-wise LUT gave the worst uncertainties. The measured distance MD was illustrated for the middle row by using even and uneven fringe projection with position 5 mm, as shown in FIG. 7.

FIG. 7(a) shows the case for even fringe projection using a single average coefficient set. It is clear that the measured depth is a function of x-coordinate giving large systematic errors. In FIG. 7(b) even fringe projection using a LUT of coefficients for each pixel shows the removal of systematic errors. With FIG. 7(c), it can be seen that uneven fringe projection with a physical reference plane gives similar performance to even fringe projection with a LUT whilst only requiring < 1/1000^{th} of the calibration data to be retained. Further examination of the AMD and STD values in Table 1 for both these cases shows similar values. In FIG. 7(d) uneven projection was used with a virtual reference plane and it can be seen that the random measurement uncertainty is the smallest obtained.

TABLE 1

| | Uneven Projection | | Uneven Projection | | Even Projection | | Even Projection | |
|---|---|---|---|---|---|---|---|---|
| TD | with virtual plane | | Without virtual plane | | with LUT | | without LUT | |
| (mm) | AMD | STD | AMD | STD | AMD | STD | AMD | STD |
| −45 | −45.007 | 0.0334 | −45.007 | 0.0462 | −45.007 | 0.0397 | −45.125 | 2.4344 |
| −5 | −4.944 | 0.0388 | −4.944 | 0.0491 | −4.952 | 0.0484 | −4.967 | 0.2876 |
| 5 | 5.017 | 0.0368 | 5.018 | 0.0497 | 4.993 | 0.0419 | 5.010 | 0.3012 |
| 45 | 44.959 | 0.0458 | 44.959 | 0.0576 | 44.991 | 0.0505 | 45.160 | 2.7385 |

For the proposed uneven fringe projection, since the relationship between phase and depth is independent of the x-coordinate along one row, the coefficients can be calculated for rows with holes by just using the valid measurement pixels that are away from the holes. In fact, the pixels near to the edge have effects on calibration and they will be removed for calculating the coefficients. The STD and the AMD were calculated for each row by projecting uneven fringe patterns, as shown in FIG. 8. From this it can be seen that the AMDs are almost the same for different rows and the STDs of the middle rows are a little smaller than the top and bottom rows. Because the projector generates more distortion on the bottom of the field of the view, the bottom rows have larger uncertainties.

FIG. 7 shows the measured depth by use of uneven and even fringe projection from position 5 mm for the middle row. FIG. 8 shows the measured depth and standard deviation using uneven fringe projection. When compensating for lens radial distortion (equation 7), the accuracy for the depth data improves. The measured STD with uneven projection and with a virtual plane becomes <33 μm for all TD, compared to 32 to 45 μm when the distortion is not accounted for.

The x- and y-coordinates were calibrated using the method described by H. O. Saldner, and J. M. Huntley, “Profilometry using temporal phase unwrapping and a spatial light modulator-based fringe projector,” Opt. Eng. 36(2), 610-615 (1997) by calculating the distance between two holes' centre with known distance 50 mm. Because of distortion, the captured holes have elliptical shapes. In order to get a precise value, a direct least square fitting of ellipses method was used to fit ellipses to the extracted pixels on the holes edge and then calculated the centre of ellipses with sub-pixel accuracy, as proposed by A. Fitzgibbon, M. Pilu, and R. B. Fisher, “Direct least square fitting of ellipses,” IEEE Trans. PAMI, 21, 476-480 (1999). The following coefficients were obtained: n_{c}=514.59, m_{c}=384.84, D=0.20765, E=0.0002775. The first two parameters are the cross of the z-axis with the detector array in pixels and the last two are constants representing the expected linear change in demagnifications with depth. Using these coefficients and the depth, the distance between the centres of the two holes was measured when the plate was in the test positions, see Table 2.

TABLE 2

| TD (mm) | −45 | −5 | 5 | 45 | AMD | STD |
|---|---|---|---|---|---|---|
| x = 50 | 50.0022 | 49.9861 | 49.9985 | 49.9548 | 49.985 | 0.0215 |
| y = 50 | 49.9644 | 49.9747 | 50.0297 | 50.0168 | 49.996 | 0.0317 |

When radial distortion compensation is applied to the x-y data—as is required for a larger angular field of view (˜160 mm is evaluated in this case), it is found that the measurement errors may be kept to <22 μm, see Table 3, which shows the calibration results for x and y with uneven fringe projection and radial distortion compensation.

TABLE 3

| TD (mm) | −45 | −5 | 5 | 45 | AMD | STD | Error |
|---|---|---|---|---|---|---|---|
| X1 = −90.5 | −90.7039 | −90.4892 | −90.4945 | −0.4002 | −0.5220 | 0.1288 | 0.0220 |
| X2 = 90 | 89.7464 | 90.0230 | 90.1001 | 90.1099 | 89.9949 | 0.1701 | 0.0051 |
| Y1 = −70.5 | −70.2949 | −70.4812 | −70.4854 | −70.6786 | −70.4850 | 0.1567 | 0.0150 |
| Y2 = 70 | 70.0795 | 70.0562 | 69.9794 | 69.8265 | 69.9854 | 0.1142 | 0.0146 |

In conclusion, a novel uneven fringe projection approach has been explored to generate even uniform fringes on the planes vertical to the imaging optical axis. Based on the uneven fringe projection, the relationship between phase and depth becomes a simple equation of the systematic parameters, independent of x-coordinate. This approach makes a look up table unnecessary and a virtual reference plane available to reduce the uncertainties from the measured reference plane. The experimental results verify that using uneven fringe projection gives more precise measurements than the existing even fringe projection methods. This uneven fringe projection method can also be used in Fourier profilometry to remove the fringe carrier accurately.

### Lateral Chromatic Aberration Correction in Colour Full Field Fringe Projection

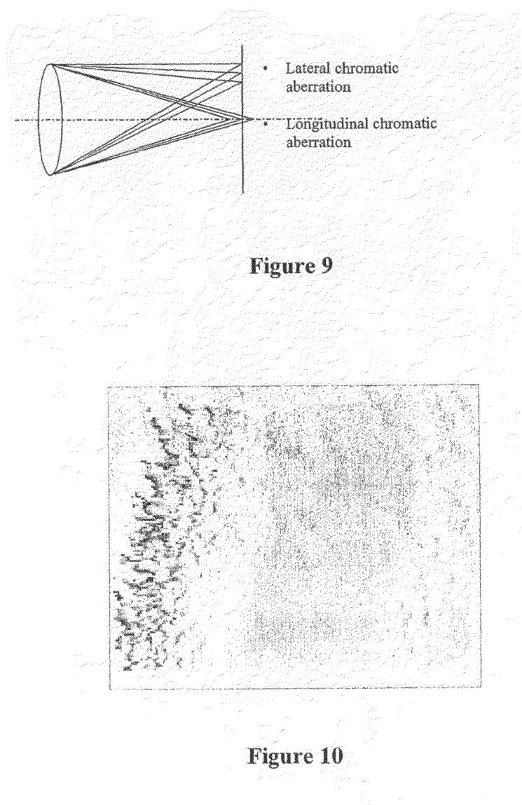

The lenses used for projection and imaging normally have a finite aperture in order that sufficient depth of field is obtained, i.e. the projected image is sharp across the entire image despite the presence of an angular deviation from normal projection. Chromatic aberration in a lens is manifest in two ways: as a longitudinal effect and a lateral effect, as shown in FIG. 9. Longitudinal chromatic aberration produces defocusing between colour layers. This affects the sharpness of the image but does not critically change the effective wavelength of the projected fringes and therefore the absolute phase measured.

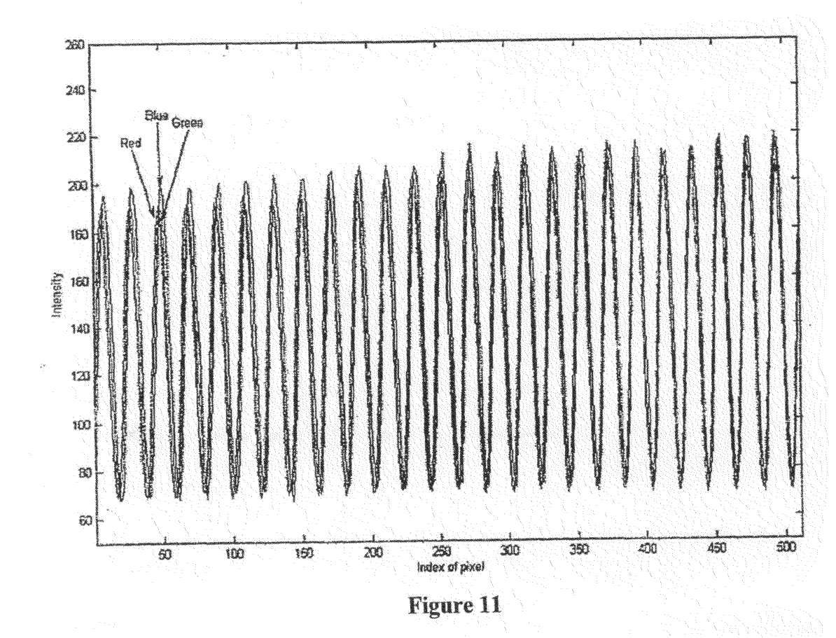

In contrast, lateral chromatic aberration between colour channels directly affects the pitch of the projected fringes and therefore the apparent wavelength of the projected fringes. FIG. 10 shows the shape of a flat board measured using optimum 3-wavelength interferometry, as described in C E Towers, D P Towers, J D C Jones, “Absolute Fringe Order Calculation Using Optimised Multi-Frequency Selection in Full Field Profilometry”, Optics & Lasers in Engineering, Volume 43, pp. 788-800, 2005, the contents of which are incorporated herein by reference, with 100, 99 and 90 projected fringes in the red, green and blue channels of a colour projection system. It is clear from this that when the values 100, 99, 90 are used in the calculation large errors are produced, i.e. the surface does not appear flat particularly at the left and right hand side. With no chromatic aberration a flat shaded surface would be produced. FIG. 11 shows the corresponding signal where the same number of fringes was projected on the red, green and blue channels. The peaks and troughs of the fringes can be seen to be coincident on the right hand side of the graph whereas on the left hand side they are not. This is a direct consequence of lateral chromatic aberration.

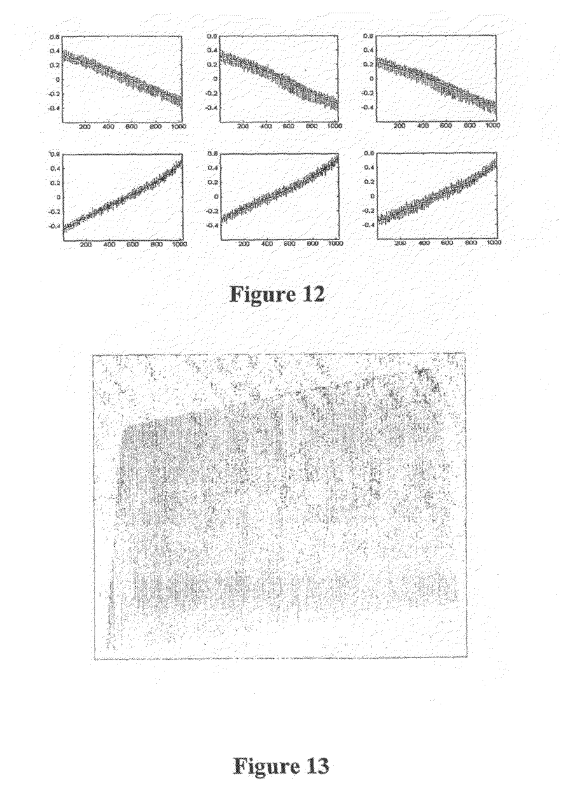

Using phase stepped intensities of the patterns depicted in FIG. 11, as described by for example K. Creath, in “Phase measurement interferometry techniques,” in Progress in Optics Volume XXVI, Ed. E. Wolf (North Holland Publishing, Amsterdam, 1988), the contents of which are incorporated herein by reference, a wrapped phase measurement for each colour channel can be calculated. For data captured across a flat board the phase may be unwrapped spatially to obtain a contiguous phase distribution. Taking the unwrapped phase in the green channel as reference and subtracting this from the unwrapped phase in the red and blue channels for a row of pixels near the top, middle and bottom of the image, the graphs in FIG. 12a), b) and c) are obtained respectively for 3 rows of the image and when the same number of fringes are projected in each colour channel. These show that chromatic aberration is approximately constant from top to bottom of the projected image. Furthermore, the effect of lateral chromatic aberration on the phase difference between colour channels is approximately a linear function.

The effects of lateral chromatic aberration can be removed from the calculated unwrapped phase by using a linear distortion model. The average slope of the graphs presented in FIG. 12 can be calculated. Hence an average lateral distortion, εₘ, in terms of the number of projected fringes across the field of view can be determined between colour channels. This value can be used to modify the number of projected fringes requested, F (the value programmed into the image sent to the projector), on one of the colour channels with respect to that on another channel, giving the actual number of fringes as imaged by the camera, Fₘ: Fₘ=F+εₘ. Thus, the actual numbers of projected fringes Fₘ in each colour channel can be used in the calculation of fringe order to obtain a robust measurement of the unwrapped phase.

As an example, in a typical fringe projection configuration with the imaging lens at an F# of 16, and taking the green channel as a reference the data in Table 4 below are obtained for the average lateral distortion, εₘ, for 100, 99 and 90 numbers of projected fringes in the red and blue channels.

TABLE 4

| | Fringe Numbers | | | | | |
|---|---|---|---|---|---|---|
| | 100 | | 99 | | 90 | |
| | R | B | R | B | R | B |
| Average lateral distortion (number of | −0.1548 | 0.1956 | −0.1542 | 0.1985 | −0.1544 | 0.1946 |
| projected fringes across the field of | | | | | | |
| view) | | | | | | |

Taking the average levels of distortion and starting from 100, 99 and 90 in the blue, green and red channels, the actual number in the blue is 100+0.1956; and the actual number in the red is 90-0.1544. Using the modified values: 100.1956, 99, 89.8456 to calculate the unwrapped phase, the measured shape of the flat board that is obtained is correct, as shown in FIG. 13.

A mathematical simulation of the phase measurement process can be used to assess the accuracy with which the average lateral chromatic aberration needs to be measured in order to obtain the correct unwrapped phase. It is found that when using the optimum multi-wavelength setup, as described by C E Towers, D P Towers, J D C Jones, in “Absolute Fringe Order Calculation Using Optimised Multi-Frequency Selection in Full Field Profilometry”, Optics & Lasers in Engineering, Volume 43, pp. 788-800, 2005, the contents of which are incorporated herein by reference, with 100, 99 and 90 projected fringes an error of 0.07 in the value for the number of projected fringes can be tolerated in the data containing 99 and 90 projected fringes and an error of 0.02 in the data containing 100 projected fringes. Taking the working distance as the distance from the camera to the measurement position, the average lateral distortion values for a ±5% change in working distance has been evaluated and the results are summarised in Table 5 below.

TABLE 5

| Working distance | R | B |
|---|---|---|
| −5% | −0.1422 | 0.2030 |
| 0% | −0.1548 | 0.1956 |
| +5% | −0.1629 | 0.1903 |

The maximum change in distortion is 0.0126 fringes across a ±5% change in working distance, i.e. for a measurement depth range of 10% of the average working distance. The theoretical model showed that the distortion must be known to better than 0.02 fringes in order for errors not to propagate into the unwrapped phase. Therefore the proposed lateral chromatic aberration compensation technique is robust with respect to working distance. From FIG. 12 it can be seen that small differences are present in the lateral chromatic aberration considering pixel rows at the top, middle and bottom of the image. A calculation of εₘ for each row down the image shows that the distortion varies by <0.03 fringes across the entire image. Therefore, the proposed linear chromatic aberration compensation model is robust across the field of view.

The various aspects of the present invention can be used separately or in combination to provide an integrated shape, colour and texture measurement system. Using the invention, the following advantageous features can be obtained: directly calibrated shape data, a colour shape measurement system with shape and colour data obtained from the same pixels, with multi-view data accurately located within a common co-ordinate system, and texture information resolved to specific surface regions. Having all of this included in a single system and under computer control provides a sophisticated, and flexible sensor that can be used to capture high quality pictures at rates significantly higher than previously achievable.

A skilled person will appreciate that variations of the disclosed arrangements are possible without departing from the essence of the invention. Accordingly, the above descriptions of specific embodiments are made by way of examples only and not for the purposes of limitation. It will be clear to the skilled person that minor modifications may be made without significant changes to the operation and features described.

1. A method for combining shape data from multiple views in a common co-ordinate system to define at least one of a 3-D shape and a colour of an object, the method comprising:
projecting one or more optical datum onto the object surface;
projecting light over an area of the object surface;
capturing light reflected from the object surface;
using the optical datum as reference points in multiple views of the object; and
using the multiple views and the reference points to determine the shape of the object.

2. A method as claimed in claim 1 wherein three or more optical datum are projected onto the object surface.

3. A method as claimed in claim 2, comprising:
using at least one of a cold source and a non-thermal source including a single or multi mode optical fibre to project the optical datum.

4. A shape measurement system for measuring the shape of an object, the system comprising:
means for projecting one or more optical datum onto the object surface;
a projector for projecting light over an area of the object surface;
a detector for capturing light reflected from the object surface; and
means for using the optical datum as reference points in multiple views of the object to determine the shape of the object.

5. A computer program on a computer readable medium for use in a shape measurement system for measuring a shape of an object, the shape measurement system having means for projecting one or more optical datum onto the object surface; a projector for projecting light over an area of the object surface; a detector for capturing light reflected from the object surface, wherein the computer program comprises instructions for using the optical datum as reference points in multiple views of the object to determine the shape of the object.

6. A method as claimed in claim 1 wherein each optical datum has a size sufficient to cover one or more pixels at the detector.

7. A system for measuring a bi-directional reflectance distribution function (BDRF) of an object's surface, the system comprising:
an optical shape sensor configured to project light onto an object, capture light reflected from the object and use the captured light to determine the shape of at least part of the object; and
means for determining an angular spread of the captured light about a normal to a surface of the object and for using the angular spread to determine the BDRF.

8. A method for measuring a bi-directional reflectance distribution function (BDRF) of an object's surface, the method comprising:
obtaining shape information from an optical shape sensor;
determining an angular spread of light captured by the sensor about a normal to a surface of the object, the normal being relative to the shape information; and
using that the angular spread to determine the BDRF.

9. A computer program for use in a method for measuring a bi-directional reflectance distribution function (BDRF) of an object's surface, the computer program or comprising instructions for obtaining shape information from an optical shape sensor; determining an angular spread of light captured by the sensor about a normal to a surface of the object; and using the angular spread to determine the BDRF.

10. An optical shape sensor comprising:
a projector for projecting optical fringes onto an object;
a detector for capturing fringes reflected from the object; and
means for using the captured fringes to determine the shape of the object, wherein the projected fringes are unevenly spaced.

11. An optical shape sensor as claimed in claim 10 wherein a spacing of the unevenly spaced fringes is selected to remove at least one of distortion and aberration.

12. An optical shape sensor as claimed in claim 10 wherein a spacing of the unevenly spaced fringes is selected so that the fringes at the object are evenly spaced.

13. A method for calibrating an optical shape system, the method comprising:
projecting optical fringes towards an object;
capturing fringes reflected from the object; and
using the captured fringes to determine the shape of the object, wherein the projected fringes are unevenly spaced and selected so that the fringes at the object are evenly spaced.

14. A method for compensating for chromatic aberration in a colour fringe projection system having a projector for projecting a plurality of different colour light fringes onto an object and a camera for capturing light fringes reflected from the object, the method comprising scaling captured fringes to an expected number of fringes for each colour channel.

15. A method as claimed in claim 1, comprising:
using at least one of a cold source and non-thermal source to project the optical datum.

16. A method as claimed in claim 15 wherein the at least one of a cold source and non-thermal source is one of a single and multi mode optical fibre.

17. A system as claimed in claim 4 wherein each optical datum has a size sufficient to cover one or more pixels at the detector.

18. A computer program as claimed in claim 6 wherein each optical datum has a size sufficient to cover one or more pixels at the detector.

19. An optical shape sensor as claimed in claim 11 wherein the spacing of the unevenly spaced fringes is selected so that the fringes at the object are evenly spaced.
